(19) United States
(12) Patent Application Publication
(10) Pub. No.: US 2023/0259512 A1
(43) Pub. Date: Aug. 17, 2023

(54) DIGITAL PERSONAL ASSISTANT

(71) Applicant: Vi Labs Ltd, Tel-Aviv (IL)

(72) Inventors: Elad HOFSTETTER, Tel-Aviv (IL); Gidon RAVNER, Tel-Aviv (IL); Jonathan APRASOFF, Kfar-Saba (IL); Menahem REIF, Rishon-LeZion (IL)

(73) Assignee: Vi Labs Ltd, Tel-Aviv (IL)

(21) Appl. No.: 18/136,917

(22) Filed: Apr. 20, 2023

Related U.S. Application Data
(63) Continuation of application No. 16/965,323, filed on Jul. 28, 2020.
(60) Provisional application No. 62/626,728, filed on Feb. 6, 2018.

(51) Int. Cl. G06F 16/2457

(52) U.S. Cl. CPC G06F 16/24575

(57) ABSTRACT

A system for providing information to a user is described. The system includes a remote database communicating with a plurality of user devices. The remote database includes a plurality of media snippets and a clustering engine for clustering users of the plurality of user devices based on at least one user-related parameter and identifying a subset of media snippets from the plurality of media snippets most relevant to users of a cluster.

### RELATED APPLICATIONS

This application is a Continuation of U.S. patent application Ser. No. 16/965,323 filed on Jul. 28, 2020, which is a National Phase of PCT Patent Application No. PCT/IL2019/050143 having International Filing Date of Feb. 6, 2019, which claims the benefit of priority under 35 USC § 119(e) of U.S. Provisional Patent Application No. 62/626,728 filed on Feb. 6, 2018. The contents of the above applications are all incorporated by reference as if fully set forth herein in their entirety.

### FIELD AND BACKGROUND OF THE INVENTION

The present invention relates to a system for providing information such as feedback to a user and, more particularly, to a system that tags media snippets based on user clustering and combines selected media snippets into a media file playable to a user based on parameters related to the user's activity.

Individuals wanting to maximize the benefits of exercise often turn to personal trainers for guidance and motivation. A personal trainer can provide invaluable expertise and support and can help the individual overcome emotional and physical hurdles on the road to physical fitness goals.

However, personal trainers are not an ideal solution for many individuals. Personal trainers can be expensive and scheduling training appointments can be an inconvenience. In addition, personal trainers are limited in their ability to record and analyze data produced from each workout session in an efficient real-time manner.

Recent years have seen the advent of software applications that provide digital personal assistant functions for replacing or augmenting the functions of human personal trainers.

Digital personal assistants can range in complexity from simple training regimen building systems (e.g. FitnessBuilder app for iOS and Android) to fitness monitoring and feedback systems (e.g. Strava app for iOS and Android). The latter can provide training goals and guidelines as well as constructive and motivational feedback during a training session.

While advanced digital personal assistants can efficiently record and analyze data produced from a workout session and generate future training sessions accordingly, they lack the personal ‘touch’ of human trainers and thus, feedback provided by such systems typically lacks the emotional ‘connection’ required for motivating an individual to exercise.

### SUMMARY OF THE INVENTION

According to one aspect of the present invention there is provided a system for providing a user with information such as feedback to a workout regimen or query. The system comprises a remote database communicating with a plurality of user devices, the remote database including a plurality of media snippets; a clustering engine for clustering users of the plurality of user devices based on at least one user-related parameter and identifying a subset of media snippets from the plurality of media snippets most relevant to users of a cluster; and associating a user of a user device with the cluster and providing the subset of media snippets to a memory of the user device.

According to further features in preferred embodiments of the invention described below, the user device is a wearable device configured for sensing at least one physiological parameter of the user.

According to still further features in the described preferred embodiments the user related parameter is selected from the group consisting of a gender of the user, an activity of the user, a performance metric of the user, a mood of the user, a physiological parameter of the user, a profile of the user, a fitness level of the user, a workout intensity of the user, a number of workouts per week of the user, a route or location of the user, a stamina of the user and a music preference of the user.

According to still further features in the described preferred embodiments the user device includes a processor for selecting one or more media snippets from the subset of media snippets and combining selected media snippets into a media file to be presented to the user.

According to still further features in the described preferred embodiments the plurality of media snippets are audio snippets and the media file is a spoken message.

According to still further features in the described preferred embodiments the plurality of media snippets are text snippets and the media file is a text message.

According to still further features in the described preferred embodiments the media file is generated in accordance with a type of user activity, a gender of the user, a user-related physiological parameter, and/or a mood of the user.

According to still further features in the described preferred embodiments each of the audio snippets is labeled as male or female voice, type of intonation and/or a type of user activity.

According to still further features in the described preferred embodiments the user is re-associated with a different cluster following an activity.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Implementation of the system and method of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computing device using any suitable operating system. In any case, selected steps of the present invention could be described as being performed by a data processor, such as a computing platform for executing a plurality of instructions.

### BRIEF DESCRIPTION OF THE SEVERAL VIEWS OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 illustrates an embodiment of the present system communicating with a device of a user.

FIG. 2 illustrates media snippet generation and storage using an embodiment of the present system.

FIG. 3 illustrates user clustering based on user-related parameters using an embodiment of the present system.

FIG. 4 illustrates user re-clustering based on a change in a user-related parameters using an embodiment of the present system.

FIG. 5 is a graph showing heart rate based clustering according to embodiments of the present invention.

### DESCRIPTION OF SPECIFIC EMBODIMENTS OF THE INVENTION

The present invention is of a system which can be used to provide feedback to a user during an activity such as a training session. Specifically, the present invention can be used to construct and relay user-specific feedback to a user during exercise.

The principles and operation of the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Digital personal assistants are well known in the art and range in function from simple voice recognition systems to more advanced systems such as Apple's Ski, Amazon's Alexa or Microsoft's Cortana.

The latter systems were developed in order to assist an individual in everyday tasks such as searching, scheduling appointments and the like. Over the last few years, such systems have slowly learned to move beyond the basics of providing simple information in response to a query to more complex tasks like managing an individual's information and predicting user patterns and needs. Such abilities have increased the emotional attachment of users to such systems to a point where users anthropomorphize devices having these capabilities.

While personal assistant functions have been applied to fitness monitoring and feedback, attempts at providing a software system that can replace human personal trainers have focused on matching feedback to an activity in order to maximize performance.

For example, U.S. Pat. No. 8,715,139 discloses an exercise system that can provide feedback based on a user's activity. Feedback can be constructed from audio file packages of different types or styles of voices.

While varying feedback based on a user's activity can be beneficial, it does not address variations between the way different users react to different feedback styles.

While reducing the present invention to practice, the present inventors devised a system that takes into account the way different users respond to different types of the same feedback.

As is further described hereinbelow, the present system clusters users based on user-related parameters and provides a collection of media snippets to a user based on cluster association. Various media snippets can then be used by the user's device to construct a media file (e.g. audio file) playable to the user. Such a media file can include information such as feedback to a user's activity or a response to a user query.

Thus, according to one aspect of the present invention there is provided a system for providing information to a user.

The system includes a remote database communicating with a plurality of user devices through a communication network such as the internet. The user devices can be personal communication devices such as smartphones, wearable devices such as smart watches, smart earphones and the like. The user devices or secondary device attached thereto or communicating therewith (e.g. earphones) can include physiological sensors and the like for sensing at least one physiological parameter of the user (e.g. heart-rate). A secondary device can be, for example, heart rate sensing earphones utilizing a photoplethysmography (PPG) sensor having at least one photodiode for generating light at a wavelength of 530 nm and at least one photodetector for detecting light reflected from the tissue.

The remote database can be a server or any computing platform suitable for storing and processing data. The remote database can store a plurality of media snippets (on any suitable storage medium). A media snippet can be a data file that represents information or a portion thereof. A media snippet can be an actual recording or a syntax representation which, in the case of audio, can be synthesized using a voice synthesis algorithm on the user device in real time based on syntax defined in the remote server.

In any case, an audio-type media snippet can be (or represent) a spoken word, phrase or sentence prerecorded by an individual or artificially synthesized. An image-type media snippet can be (or represent) an image or a portion of image (e.g. background), while a video-type media snippet can be (or represent) a portion (e.g. one or more frames) of a video file.

The media snippets can be tagged according to use in a sentence (in the case of audio snippets) or the intonation of the speaker (excited, normal, mad etc.), using a simple coding in the file name. A file with an excited intonation will receive the suffix _Excited, for instance. In addition, provision and use of each specific snippet or media file constructed therefrom for each specific user can be documented (counter) so as to prevent overuse of certain snippets per user/cluster. Every time a snippet or media file is used, this use is logged in the user's records. The device also holds a table detailing the number of times each snippet or media file can be heard in a single session and in total. For instance, a joke will be limited to playing just one time and never again, but a reminder to drink after a run on a hot day will be restricted to playing just once every session, and the user might hear it again the next time he runs and the temperature is above a certain threshold.

Various media snippets can be combined into a media file. For example, words, phrases or sentences can be combined into a playable audio file or various images can be combined into a playable image file.

The media snippets and any combinations thereof used to construct a media file playable to the user are selected based on a cluster of users to which the user is associated by the remote database. In that respect, the remote database includes a clustering engine for clustering users of a plurality of user devices based on at least one user-related parameter. The user-related parameter can be a gender of the user (male or female), an activity of the user, a performance metric of the user, a mood of the user, a physiological parameter of the user, a profile of the user, a fitness level of the user, a workout intensity of the user, a number of workouts per week of the user, a route or location of the user, a stamina of the user and/or a music preference of the user.

User-related parameters can be categorized as first or second order parameters. First-order parameters are requested by the system (via audio or text) or are measured directly. First order parameters such as a user's height, weight, training goals and the like can be provided by the user during on-boarding or upon specific request by the system. The user-related parameter can be provided to the remote database directly from the user device (upon permission from the user). In the case of a smartphone-type user device, a dedicated application can be used to automatically and/or manually provide the information to the remote database.

Parameters such as physiological parameters (e.g. heart rate), speed, training durations, geographic information and the like can be automatically collected by the system using sensors on the user device. Additional parameters can be collected by specific questions during or after a training session such as ‘Was this session hard?’, ‘How many times a week do you train?’. The system can also gather information from 3^{rd} party services (e.g. music the user listens to on Spotify).

Second-order parameters are extracted or inferred from the first-order parameters. For example, the system can utilize the geographic information measured during training sessions (e.g. based on GPS and/or cellular and/or WiFi and/or Bluetooth) to estimate the user's home location. The system can also detect when a user is away from home and traveling. Another example of information extracted from geographic data is preferred running routes. By detecting repeated routes, the system can tell if the user is re-using a route, and can log and attach an action to this information. More complex models are used to map ‘soft’ parameters like the user's motivation, primarily based on the user's tendency to follow through to the targets the user or system outline (e.g. a user who constantly sets a 15 km run, but always stops after 10 km is labeled as a low-motivation user). The system also maps the parameters affecting a user's motivation by randomizing settings and exploring correlations between behaviors. For instance, it will randomly try a different training method and approach for a portion of the training session and measure the motivation in that section vs. that of other users to identify the user's compatibility to a training method.

Once the first-order parameters are uploaded to the remote database, they are stored under the user's files. The remote database will then re-run the clustering engine on the fresh data, and include it in the analysis. The clustering engine will receive as input all the first-order parameters. The clustering engine will then analyze the data in several steps. First, the data in the time series (physiological data, speeds, geographical data etc.) are filtered and noise is extracted. Then, the features for clustering are calculated using equations, statistical models, or other software tools such as Google Tensorflow or Amazon's AWS Elastic Container Services and/or similar tools. Features derived from the first order parameters are stored in the user's profile as second-order parameters. Once all the features are calculated, they can be used to cluster users. Some clustering models are a simple threshold, like checking if the user's speed variability (a second order parameter derived from speed) is higher or lower than a pre-defined number. Other clustering engines are a high dimensionality models trying to model things like motivational preferences based on numerous first and second order parameters. The results of the clustering engine, the third order parameters, are also saved in the database.

An example of the clustering engine's analysis is the assessment of a user's probability of staying an active user in the future. The user can be labeled as either a user that has left the service, is going to stay with the service or is in transition and about to leave. To cluster a user to one of these groups, the system can utilize a user's fitness level, age, number of times he opened the smartphone application in 7 days, number of training sessions and their length, compliance trend etc. These features are normalized, to account for their respective statistical characteristics and compared to the labeled data in the system, using a k-Nearest-Neighbor method to find the closest group in the feature space. The users are labeled according to the closest group found. Such analysis can be effected using Python and the Sklearn (scikit-learn 0.19.1 software, open source) and/or similar tools.

Once a user is clustered by the clustering engine of the remote database, a subset of media snippets most relevant to the users of the cluster is identified by the remote database and is provided to a memory of the user device. Based on the cluster, it is believed that the media snippets provided are those that can be used to construct a media file that would be most effective in relaying information to the user. Effectiveness depends on several factors such as the attachment the user has to the system's assistant (as measured, for example, by compliance to a workout), how the media file's wording and intonation fit the user's character, motivational preferences, fitness education level, and the believability of the media file. Fitness education is a measure of the user's knowledge of terms and concepts in the field of fitness and physiology. A user with a low fitness education might hear a simplified explanation regarding muscle cramps and stretching after a run. A user with a high fitness education grade will hear the same explanation, but without simplifications and with direct references to terms in the field. A media file is believable if the user understands why it is provided. For instance, if a media file warns the user about slipping on wet roads on a sunny day, the believability would be very low.

Additional clustering parameters that can determine usage of media snippets/files includes, for example:
i. Sex—Males and Females have different physiologies, which can affect the training advice given. Matching training goals with user's abilities increases the system's believability and the probability of user compliance.
ii. Age—Age can affect the training a user will get. Elderly users will not be pushed to exert themselves as hard as younger users. This differentiation helps keep users safe and increase believability.
iii. Goals—Based on user inputs. At the end of a run, for example, if a user is trying to lose weight, the system will offer suggestions for a post-workout meal. If the user is trying to reduce stress, the system will offer a post-run breathing exercise or guided meditation session. This differentiation increases the probability of users to comply.
iv. Fitness level—A user that struggles to finish a 5 K run will hear a media file with an exited intonation after completing the run. A user labeled as fit user will not get the same level of ‘excitement’ for an easy run. This helps match the emotional reward with the effort.
v. Verbosity—some users like to have a lot of interaction and some like the interactions to be shorter. Matching a user's preference will increase the probability he will listen to the information and not disregard it.
vi. Motivational preferences—Some users like a positive approach to cheer them on, and some like more of a ‘tough love’ approach. Using the right approach increases the probability of users to comply.

Clustering and provision of media snippets to a user can be effected upon system initialization and/or periodically as user parameters and/or clustering of users change. For example, a change in a user fitness level as detected by the present system can initiate re-clustering of the user and re-provision of media snippets to the memory of the user's device.

In addition to the media snippets selected based on user clustering, the present system can also provide media snippets that are selected based on user specific information. Such snippets can be used to address the user (name of user), to relate to an age of the user (based on user's birthday), a user's location (based on geo-location) and the like.

As is mentioned hereinabove, the media snippets are assembled into a media file playable to the user. Such a media file can provide information to the user in response to a request or query or it can provide feedback to a user action, user location and the like.

For example, during a run, a user will get notified every time he finishes a virtual loop of a pre-defined duration or distance. These notifications will include a few key statistics updating the user on his overall state. The system will choose which statistics to play to the user based on the clustering of this user, for instance a user interested in weight loss will be updated on the calories burned so far, and users in other clusters will not. The system will choose the snippets associated with the relevant statistics, according to the clustering and combine them with the real-time values of the different statistics.

In another example, if during a training session the user passes close to a monument or important site that is included in a pre-defined geo-fencing list, and the user is clustered at a high enough verbosity grade (and will react positively to in-run interactions), and the user is clustered as out-of-town (he's not a local), the system will play a media file with a short description of the monument and display a picture of the site or an arrow showing the general direction of the monument on the smart-phone's screen.

Furthermore, after a run, if the user has either completed his longest run, or broke a record time or speed, the system will send him a small video animated badge. The badge's animation and text vary as a function of the user's fitness and the system's estimation of his effort during the run. If the system estimated the user's effort levels were high, the badge will contain more festive animations and text, to match the reward to his effort level. So two users of different fitness levels will get different badges for the same objective result, because of their different abilities.

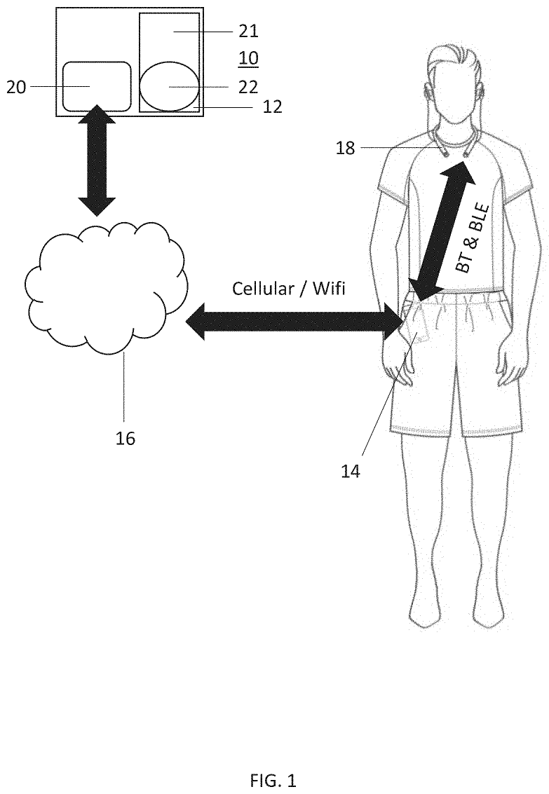

Referring now to the drawings, FIG. 1 illustrates the present system which is referred to herein as system 10.

System 10 includes a remote database 12 communicating with a user device 14 through a communication network 16. User device 14 can be a smartphone communicating with communication network 16 through a cellular or WiFi connection.

User device 14 can communicate with a secondary device 18 through a wired or wireless connection (e.g. BlueTooth). In the Example shown, secondary device 18 is a wireless headset (earphones) for providing the user with audio information and optionally having a plurality of sensors (e.g. heart rate sensor, motion sensors etc.).

Remote database 12 includes a clustering engine 20 for clustering users based on user-related parameters provided by device 14 and/or the user.

A user is associated with a cluster by clustering engine 20 and a subset of media snippets 22 of a plurality of media snippets 21 stored in remote database 12 are provided to device 14 through communication network 16. Subset of media snippets 22 are then stored on a memory of device 14.

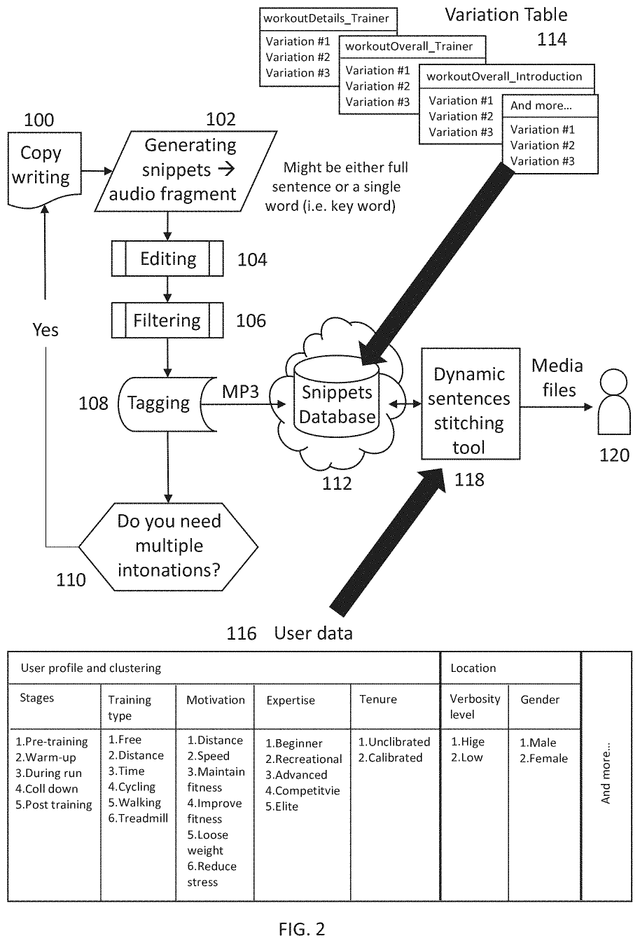

FIG. 2 illustrates an Example of media snippet generation, storage and provision using an embodiment of the present system. The media snippet generation loop starts with a copy-writing stage 100, scripting the different system responses. Scripting the snippets requires a knowledge of their inter-relations so the user will get a set of media files throughout the training session, rather than a set of unconnected media files. This script is then handed to the actor, whose voice is recorded, and the snippets generated in the snippet generation stage 102 (a machine synthesized voice can also be used to generate the sentences/snippets). The actor is guided by a director to achieve the desired media file. The media files go through editing 104 and filtering 106 by sound engineers. The content director then receives the files and checks them against the script. Media files that pass the examination go through tagging 108 according to content and intonation, and will be added to the snippet database 112 in MP3 format. According to the multiple variations check 110, this loop will be repeated, and other variations recorded, so the users will keep getting a fresh experience.

The snippet database 112 is also linked to a variation table 114 defining the possible media files that correspond to any system event and user clustering. For each possible system event (e.g. ‘User is slowing down’, ‘User started run’, ‘User is exhausted’) this table details the possible media file variations for every event, and the users for which the variations are applicable. Each variation is a set of media snippets, at the order in which they should be played.

The user data table 116 holds the information the system has regarding the specific user, including the first, second and second order parameters.

The dynamic sentence stitching tool 118 uses the snippets in the snippet database 112 and connects them into one media file to be played to the user 120. The tool 118 uses the variation table 114 in conjunction with the user data table 116 to choose the right variation. Once the variation is chosen, the tool will stitch the snippets according to the pre-defined order and send the resulting media file to the user 120.

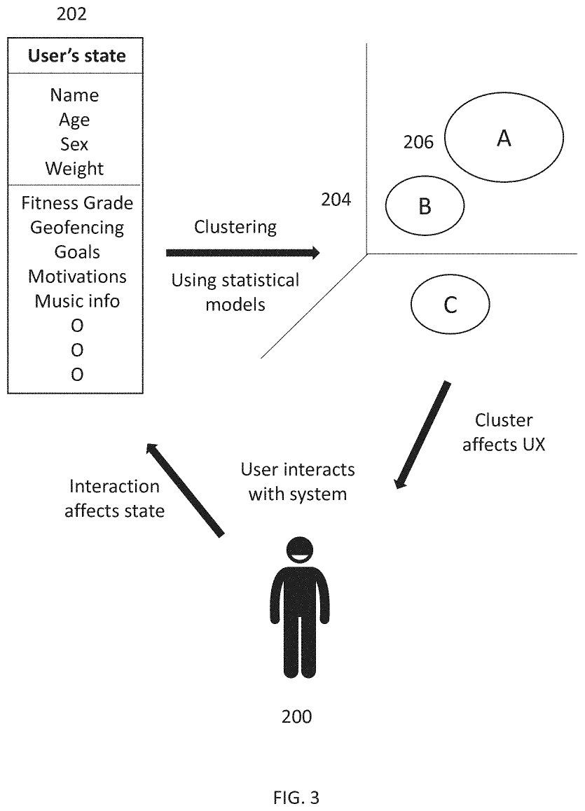

FIG. 3 illustrates an example of user clustering as effected by an embodiment of the present system. The figure depicts the clustering and re-clustering process of a user in the system. At first, the user interacts with the system 200—most likely uses it for a training session. As the user interacts with the system, data is recorded and stored. As an example, during a running session the system might record his speed, heart-rate, the music the user listens to, compliance to training guidance etc. This recorded information is then stored in the user's state 202 in the database.

The user's state 202 or user profile includes all the information the system has about a user, including first, second and third order parameters. The state 202 can change following every user interaction with the system. The first order parameters that were measured during the interaction are added to the system, and used to re-calculate the second order parameters. The clustering engine 204 will run on the first and second order parameters to update the third order parameters—the clusters the user belongs to. Defining the clusters 206 and their size and shapes might entail different statistical methods at different dimensionalities (from a two dimensional simple model, to a complex model using dozens of features based on support vector machines), deciding on the cluster a user belongs is then a matter of association. The parameters from the user's profile are normalized as per the statistical model of the clustering, and then the distances between the user's parameters and each of the clusters (e.g. A, B, and C) are calculated in the clustering space and dimensionality. The user will be clustered to the cluster point closest thereto, according to a metric that considers both the position and shape of the different clusters. This will measure the statistical likelihood the user is a part of this cluster.

Once the clustering process is done, the third order parameters in the user profile 202 are updated with the new values. The new values in the user's profile will change the user experience (UX) the next time the user interacts with the system 200, as the system might use different variations and modify other training parameters. The user's new interaction with the system will again provide new first order parameters and the full loop can re-start.

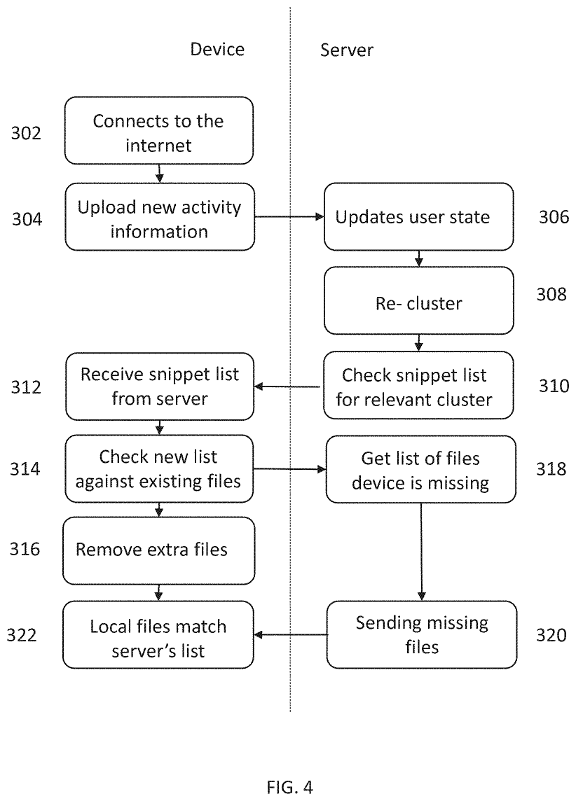

FIG. 4 illustrates an example of user re-clustering as effected by an embodiment of the present system. This Figure shows the flow of actions and messages between the user device and the remote database. Whenever the user device (e.g. a smartphone) is connected to the internet 302, any new data recorded is uploaded to the remote server 304. This information is labeled to allow the database to associate it with the correct user, date, time and activity type.

With the added information updating the user's state, or user profile in the remote database 306, the clustering engine then re-clusters the user 308.

The remote database will then check the snippet and variation table 310 to identify the relevant snippets. The user device is then provided with a copy of these media snippets (e.g. push data transfer) 312.

The user device receives the snippet list from the server and checks it against the snippets in its internal memory 314. In case some of the snippets in the device's memory are not found on the new list, they are labeled as old and deleted 316. This might be because the user was re-clustered, because the content editors removed it from the tables, or because the user already heard it numerous times and the system doesn't allow for it to be played again.

Some files on the list may be missing from the local device's memory, and they are either new media snippets, or snippets that were previously not assigned to this user because of his profile parameters which changed. The local device will update the remote database with regards to the files missing 318 in the local memory and the database will send these files to the local device 320.

At the end of the process the device will erase the files it doesn't need and will retrieve files it was missing to match the device memory with the snippet list found on the remote database 322.

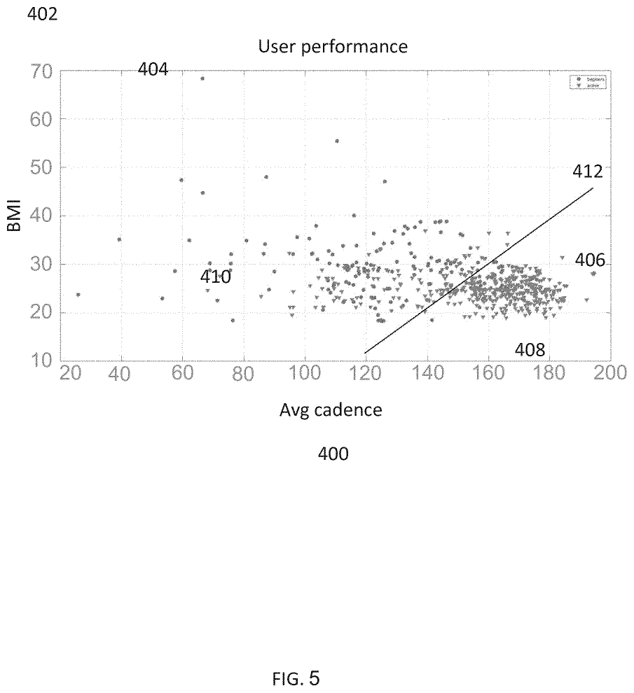

FIG. 5 illustrates a simplified clustering ‘engine’. The X axis 400 of the graph is the average cadence for a user, and the Y axis 402 represents the BMI (Body Mass Index) of a user. Every symbol on the graph represents a user. The circles 404 are users which labeled themselves as ‘Beginners’ and the triangles 406 are users which labeled themselves as ‘Active’ when asked about their activity levels.

One can see how the triangles 406 tend to be on the right bottom side 408 of the graph, meaning they have a lower BMI (less overweight) and a higher cadence, normally indicating that these are runners. The ‘beginner’ circles 404 are more widely dispersed, but they are more to the left and higher on the graph 410, meaning that they tend to walk rather than run, and have a higher body mass.

The diagonal line 412 crossing the graph indicates the threshold resulting from the clustering analysis. This means that after a statistical analysis of the two groups, beginners and active, if the engine had to guess in what group does a new unlabeled user belongs, this line is the border between the two groups. Any point to the right of this line will be labeled as an ‘Active’ user and any point to the left will be labeled as ‘Beginner’. This is a simple example, but the same principle can be used in a higher dimensionality, enabling better results. Also, the models are not limited to a binary choice, as it is possible that more than two clusters better describe the population.

As used herein the term “about” refers to ±10%.

Additional objects, advantages, and novel features of the present invention will become apparent to one ordinarily skilled in the art upon examination of the following examples, which are not intended to be limiting.

Reference is now made to the following example, which together with the above descriptions, illustrate the invention in a non limiting fashion.

### Example

### Motivational Feedback

An individual can be associated with one of several possible clusters based on a user-related parameter such as ‘reaction to feedback’, i.e. the way a user reacts to feedback as measured by a statistical model based on comparisons of user's statistics before and after a guidance media file is played, and on the overall probability of a user to complete the goals prescribed by the system or by himself. Each of the clusters can include unique media snippets that enable generation of a media file specific for the intended user (specific to the cluster of the user). For example, snippets associated with such clusters can be used to construct a motivational audio file (to motivate a user during an activity) with a user-specific message and/or a user-specific intonation/voice.

The following describes a scenario during an activity in which the present system can provide an audio message to the user device in order to motivate the user. During a run, the system reacts to a decrease in running speed with the message: ‘A Little Bit Longer’, encouraging the user to push on to the end. Such a message can be varied for different users in order to maximize the effect on the user.

The message ‘A Little Bit Longer’ can take on one of four possible variations (termed herein, ‘motivational’, ‘drill sergeant’, ‘achievement’ and ‘competitive’), each mapped to a different motivational preference cluster:

(i) For Positive Feedback users: NAME, “You've been doing great—just another” KM_TO_END “to go! You got this!”

(ii) For Drill Sergeant users: NAME, “Don't you let yourself fail now!! Common, push harder!”

(iii) For Achievement Based users: NAME, “Don't stop now! If we kick it up to” NEEDED_SPEED_FOR_RECORD “we'll break our” RECORD_KM “K record!”

(iv) For Competitive users NAME, “What? you're going to let” FRIEND_NAME “win today? he kicked his run earlier. Common, let's get up to” NEEDED_SPEED_FOR_FRIEND_WIN “and send him a screen-shot when we're done!”

All CAPS words represent key-words, replaced in real time with the calculated values by the user device storing the media snippets associated with the cluster.

The following provides an example of a user associated with a ‘Positive Feedback’ cluster (i).

James is 4.3 km into his 5 k run, as his speed decreases a motivational event is triggered in the present system/device and a motivational message is constructed from audio snippets stored on James' device based on a motivational preference variation assigned to the cluster James is associated with. The user device then plays the following message to James (through the earphones):

“James, you've been doing great—just another 700 meters to go! You got this!”

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

In addition, any priority document(s) of this application is/are hereby incorporated herein by reference in its/their entirety.

What is claimed is:

1. A system for providing information to a user comprising a remote database communicating with a plurality of user devices, said remote database including:
(a) a plurality of audio snippets each representing a spoken word or phrase, wherein each of said plurality of audio snippets includes a tag for identifying a use of an audio snippet in a sentence or an intonation of said spoken word or phrase;
(b) a computing platform having a data processor for:
(i) executing a clustering engine for clustering users of said plurality of user devices based on at least one user-related motivational parameter and identifying, based on said tag, a subset of audio snippets from said plurality of audio snippets most relevant to motivating users of a cluster; and
(ii) associating a user of a user device with said cluster and providing said subset of audio snippets to a memory of said user device, wherein said user device includes a processor for selecting one or more audio snippets from said subset of audio snippets and combining selected audio snippets into a user-specific motivational audio message to be presented to the user.

2. The system of claim 1, wherein said user device is a wearable device configured for sensing at least one physiological parameter of said user.

3. The system of claim 1, wherein said at least one user-related motivational parameter is selected from the group consisting of a mood of said user, a reaction to feedback and a compliance rate of said user.

4. The system of claim 1, wherein said audio message is generated in accordance with a type of user activity, a gender of said user, or a user-related physiological parameter.

5. The system of claim 1, wherein each of said plurality of said audio snippets is labeled as male or female voice, type of intonation or a type of user activity.

6. The system of claim 2, wherein said user is re-associated with a different cluster following an activity.
